(19) United States
(12) Patent Application Publication
(10) Pub. No.: US 2015/0247031 A1
(43) Pub. Date: Sep. 3, 2015

(54) POLYMER PARTICLE DISPERSIONS WITH DIVINYLARENE DIOXIDES

(71) Applicant: DOW GLOBAL TECHNOLOGIES LLC, Midland, MI (US)

(72) Inventors: Rui Xie, Pearland, TX (US); Ludovic Valette, Perrysburg, OH (US)

(21) Appl. No.: 14/432,770

(22) PCT Filed: Oct. 17, 2013
(86) PCT No.: PCT/US2013/065385

§ 371 Date: Apr. 1, 2015

Related U.S. Application Data
(60) Provisional application No. 61/715,925, filed on Oct. 19, 2012.

(51) Int. Cl. C08L 33/12; C08L 33/08; C08L 25/06; C08L 63/00; C09D 109/00; C08K 5/1515; C09D 133/12; C09D 125/06; C09J 109/00; C09J 133/08; C09J 133/12; C09J 125/06; C08L 9/00; C09D 133/08

(52) U.S. Cl. CPC C08L 33/12; C08L 9/00; C08L 33/08; C08L 25/06; C08L 63/00; C09D 109/00; C09D 133/08; C09D 133/12; C09D 125/06; C09J 109/00; C09J 133/08; C09J 133/12; C09J 125/06; C08K 5/1515; C08L 2205/02; C08L 2205/03

(57) ABSTRACT

A toughener composition comprising a) 45 to 97 weight percent of a divinylarene dioxide; and b) 3 to 55 weight percent of a core shell rubber comprising a rubber particle core and a shell layer wherein said core shell rubber has a particle size of from 0.01 μm to 0.50 μm is disclosed. The toughener can be used in epoxy resin compositions for advanced composite, electronic, coating and structural adhesive applications.

### BACKGROUND OF THE INVENTION

1. Field of the Invention

The present invention is related to epoxy thermosets. More particularly, the present invention is related to tougheners for epoxy thermosets.

2. Background of the Invention

Epoxy thermosets are inherently brittle due to their highly cross-linked polymer network. Such a drawback has resulted in limited use of epoxy resins in many demanding applications where toughness is required. In recent years, new developments in composites, coatings, and electronics require epoxy thermosets with greater thermal stability. Increasing the thermal stability of the epoxy polymer network often requires further tightening of the polymer network with increased crosslink density, resulting in a much more brittle polymer network.

Among the methods for solving the problems, it has been attempted to blend a rubbery ingredient with an epoxy resin. Examples of these methods include (1) heating partially cross linked rubbery random copolymer particles prepared by emulsion polymerization using a nonionic emulsifier or the like to a temperature higher than the cloud point of the emulsifier, thereby coagulating them, then optionally washing the coagulate with water and mixing the same with an epoxy resin, (2) mixing a rubbery polymer latex and an epoxy resin and then evaporating off the water content to obtain a mixture, and (3) mixing a rubbery polymer latex with an epoxy resin under the presence of an organic solvent to obtain a mixture.

The methods of (1) and (2) described above are methods of dispersing polymer particles that are adhered to each other by coagulation in a viscous epoxy resin. Since the rubbery polymer particles are physically bonded to each other, pulverization or a re-dispersion operation with a considerably large mechanical shearing force is required upon mixing with the epoxy resin. The higher viscosities of the epoxy resins often make it more difficult to uniformly re-disperse the rubbery polymer particles. As a result, such processes may leave an unmixed portion, and lumpy agglomerations are sometimes formed in the unmixed portion. Furthermore, addition of polymer particles to the viscous epoxy resin often leads to a further increase in viscosity, resulting in difficulties using the dispersions. Use of epoxy reactive diluents in place of liquid epoxy resins can significantly reduce viscosity of the dispersions, but it is usually accompanied by sacrificing other properties, such as thermal stability, mechanical strength and chemical resistance.

Method (3) described above does not include a coagulating operation, so an epoxy resin composition with rubbery polymer particles dispersed uniformly can be obtained, but a great amount of water content present together with the organic solvent in the system must be separated or evaporated off. Separation of the organic solvent layer and the aqueous layer can require as long one day and one night. Additionally, the organic solvent layer and the aqueous layer are difficult to separate substantially since they form a stable emulsified suspension. Further, in a case of removing the water content by evaporation, a great amount of energy is necessary and, in addition, water soluble impurities such as an emulsifier or sub-starting materials usually used in the production of rubbery polymer latexes remain in the composition to degrade the quality.

Therefore, a need exists for a toughening system with low viscosity that provides a uniform distribution of rubbery particles in an epoxy thermoset matrix.

### SUMMARY OF THE INVENTION

In an embodiment of the present invention, there is disclosed a composition comprising, consisting of, or consisting essentially of: a) 45 to 97 weight percent of a divinylarene dioxide; and b) 3 to 55 weight percent of a core shell rubber comprising a rubber particle core and a shell layer wherein said core shell rubber has a particle size of from 0.01 μm to 0.5 μm.

### DETAILED DESCRIPTION OF THE INVENTION

### Divinylarene Dioxide

The divinylarene dioxide useful in the present invention may comprise, for example, any substituted or unsubstituted arene nucleus bearing one or more vinyl groups in any ring position. For example, the arene portion of the divinylarene dioxide may consist of benzene, substituted benzenes, (substituted) ring-annulated benzenes or homologously bonded (substituted) benzenes, or mixtures thereof. The divinylbenzene portion of the divinylarene dioxide may be ortho, meta, or para isomers or any mixture thereof. Additional substituents may consist of H₂O₂-resistant groups including saturated alkyl, aryl, halogen, nitro, isocyanate, or RO— (where R may be a saturated alkyl or aryl). Ring-annulated benzenes may consist of naphthlalene, tetrahydronaphthalene, and the like. Homologously bonded (substituted) benzenes may consist of biphenyl, diphenylether, and the like.

The divinylarene dioxide (DVBDO) used for preparing the composition of the present invention may be illustrated generally by general chemical Structures I-IV as follows:

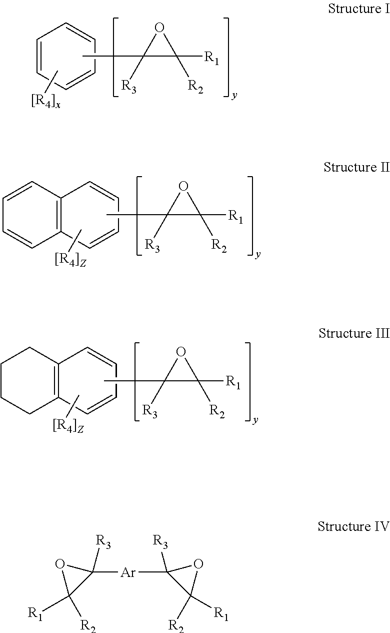

In the above Structures I, II, III, and IV of the divinylarene dioxide comonomer of the present invention, each R₁, R₂, R₃ and R₄ individually may be hydrogen, an alkyl, cycloalkyl, an aryl or an aralkyl group; or a H₂O₂-resistant group including for example a halogen, a nitro, an isocyanate, or an RO group, wherein R may be an alkyl, aryl or aralkyl; x may be an integer of 0 to 4; y may be an integer greater than or equal to 2; x+y may be an integer less than or equal to 6; z may be an integer of 0 to 6; and z+y may be an integer less than or equal to 8; and Ar is an arene fragment including for example, 1,3-phenylene group. In addition, R4 can be a reactive group(s) including epoxide, isocyanate, or any reactive group and Z can be an integer from 0 to 6 depending on the substitution pattern.

In an embodiment, the divinylarene dioxide used in the present invention may be produced, for example, by the process described in U.S. Patent Application Publication No. 2011/0251412 A1. The divinylarene dioxide compositions that are useful in the present invention are also disclosed in, for example, U.S. Pat. No. 2,924,580.

In another embodiment, the divinylarene dioxide useful in the present invention may comprise, for example, divinylbenzene dioxide, divinylnaphthalene dioxide, divinylbiphenyl dioxide, divinyldiphenylether dioxide, and mixtures thereof.

In a preferred embodiment of the present invention, the divinylarene dioxide used in the epoxy resin formulation may be for example divinylbenzene dioxide (DVBDO). Most preferably, the divinylarene dioxide component that is useful in the present invention includes, for example, a divinylbenzene dioxide as illustrated by the following chemical formula of Structure V:

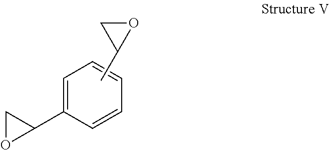

The chemical formula of the above DVBDO compound may be as follows: C₁₀H₁₀O₂; the molecular weight of the DVBDO is about 162.2; and the elemental analysis of the DVBDO is about: C, 74.06; H, 6.21; and 0, 19.73 with an epoxide equivalent weight of about 81 g/mol.

Divinylarene dioxides, particularly those derived from divinylbenzene such as for example divinylbenzene dioxide (DVBDO), are class of diepoxides which have a relatively low liquid viscosity but a higher rigidity and crosslink density than conventional epoxy resins.

Structure VI below illustrates an embodiment of a preferred chemical structure of the DVBDO useful in the present invention:

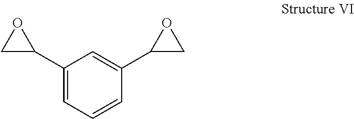 [SMILES: c1cc(C2CO2)cc(C2CO2)c1]

Structure VII below illustrates another embodiment of a preferred chemical structure of the DVBDO useful in the present invention:

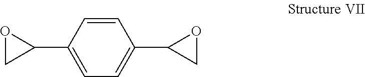 [SMILES: c1cc(C2CO2)ccc1C1CO1]

When DVBDO is prepared by the processes known in the art, it is possible to obtain one of three possible isomers: ortho, meta, and para. Accordingly, the present invention includes a DVBDO illustrated by any one of the above Structures individually or as a mixture thereof. Structures VI and VII above show the meta (1,3-DVBDO) isomer and the para (1,4-DVBDO) isomer of DVBDO, respectively. The ortho isomer is rare; and usually DVBDO is mostly produced generally in a range of from about 9:1 to about 1:9 ratio of meta (Structure VI) to para (Structure VII) isomers. The present invention preferably includes as one embodiment a range of from about 6:1 to about 1:6 ratio of Structure VI to Structure VII, and in other embodiments the ratio of Structure VI to Structure VII may be from about 4:1 to about 1:4 or from about 2:1 to about 1:2.

In yet another embodiment of the present invention, the divinylarene dioxide may contain quantities (such as for example less than about 20 wt %) of substituted arenes. The amount and structure of the substituted arenes depend on the process used in the preparation of the divinylarene precursor to the divinylarene dioxide. For example, divinylbenzene prepared by the dehydrogenation of diethylbenzene (DEB) may contain quantities of ethylvinylbenzene (EVB) and DEB. Upon reaction with hydrogen peroxide, EVB produces ethylvinylbenzene monoxide while DEB remains unchanged. The presence of these compounds can increase the epoxide equivalent weight of the divinylarene dioxide to a value greater than that of the pure compound.

In one embodiment, the divinylarene dioxide useful in the present invention comprises, for example, divinylbenzene dioxide (DVBDO), a low viscosity liquid epoxy resin. The viscosity of the divinylarene dioxide used in the process of the present invention ranges generally from about 0.001 Pa s to about 0.1 Pa s, preferably from about 0.01 Pa s to about 0.05 Pa s, and more preferably from about 0.01 Pa s to about 0.025 Pa s, at 25° C.

The concentration of the divinylarene oxide used in the composition of the present invention as the epoxy resin portion of the formulation may range generally from 45 weight percent to 97 weight percent, from 60 weight percent to 80 weight percent in another embodiment, and from 65 weight percent to 75 weight percent in yet another embodiment, based on the total weight of the composition.

### Core Shell Rubber

The second component is a core shell rubber comprising a rubber particle core and a shell layer. The core shell rubber has a particle size in the range of from 0.01 μm to 0.8 μm in an embodiment, from 0.05 μm to 0.5 μm in another embodiment, and from 0.08 μm to 0.30 μm in yet another embodiment. The core shell rubber is a polymer comprising a rubber particle core formed by a polymer comprising an elastomeric or rubbery polymer as a main ingredient, optionally an intermediate layer formed with a monomer having two or more double bonds and coated on the core layer, and a shell layer formed by a polymer graft polymerized on the core or on an intermediate layer. The shell layer partially or entirely covers the surface of the rubber particle core by graft polymerizing a monomer to the core.

In an embodiment, the polymer constituting the rubber particle core is crosslinked and has limited solubility in the divinylarene dioxide component. In an embodiment, the rubber particle core is insoluble in the divinylarene dioxide component. Further, the rubber content in the rubber particle core is generally in the range of from 60 weight percent to 100 weight percent, 80 weight percent to 100 weight percent in another embodiment, 90 weight percent to 100 weight percent in another embodiment and 95 weight percent to 100 weight percent in yet another embodiment.

Generally, the polymer constituting the rubber particle core has a glass transition temperature (Tg) of 0° C. or lower and −30° C. or lower in another embodiment. In an embodiment, the polymer constituting the rubber particle core is made from an elastomeric material comprising from 50 weight percent to 100 weight percent of at least one member selected from diene monomers (conjugated diene monomers) and (meth)arcylic acid ester monomers and 0 to 50 weight percent of other copolymerizable vinyl monomers, polysiloxane type elastomers or combinations thereof. The term ‘(meth)acryl’ is defined as acryl and/or methacryl.

The diene monomer (conjugated diene monomer) constituting the elastomeric material can include but is not limited to, for example, butadiene, isoprene and chloroprene. In an embodiment, butadiene is used. Further, the (meth)acrylic ester monomer can include, for example, butyl acrylate, 2-ethylhexyl acrylate and lauryl methacrylate. In another embodiment, butyl acrylate or 2-ethylhexyl acrylate can be used. They can be used alone or in combination.

Further, the above-mentioned elastomeric materials of a diene monomer or (meth)acrylate ester monomer can also be a copolymer of a vinyl monomer copolymerizable therewith. The vinyl monomer copolymerizable with the diene monomer or (meth)arcylic ester monomers can include, for example, aromatic vinyl monomers and vinyl cyanate monomers. Examples of aromatic vinyl monomers that can be used include but are not limited to styrene, α-methylstyrene, and vinyl naphthalene, while examples of vinyl cyanate monomers that can be used include but are not limited to (meth)acrylonitrile and substituted acrylonitrile. The aromatic vinyl monomers and vinyl cyanate monomers can be used alone or in combination.

In an embodiment, the amount of the diene monomer or (meth)arcylic ester monomer used is in the range of from 50 weight percent to 100 weight percent and, in another embodiment, from 60 weight percent to 100 weight percent based on the entire weight of the elastomeric material. If the amount of the diene monomer or (meth)arcylic ester monomer to be used for the entire rubber elastomer is less than 50 weight percent, the ability of the polymer particles to toughen a polymer network, such as a cured epoxy matrix, is decreased. On the other hand, the amount of the monomer copolymerizable therewith is, in an embodiment, 50 weight percent or less and, in another embodiment, 40 weight percent or less based on the entire weight of the elastomeric material.

Further, as an ingredient constituting the elastomeric material, a polyfuntional monomer may also be included for controlling the degree of crosslinking. The polyfunctional monomer can include, for example, divinylbenzene, butanediol di(meth)acrylate, triallyl(iso)cyanurate, allyl(meth)acrylic, diallyl itaconate, and diallyl phthalate. The polyfunctional monomer can be used in an amount in the range of from 0 weight percent to 10 weight percent, from 0 weight percent to 3 weight percent in another embodiment, and from 0 weight percent to 0.3 weight percent in yet another embodiment, based on the entire weight of the elastomeric material. In the case where the amount of the polyfunctional monomer exceeds 10 weight percent, the ability of the polymer particles to toughen a polymer network, such as cured epoxy matrix is decreased.

Optionally, a chain transfer agent may be used for controlling the molecular weight or the crosslinking density of the polymer constituting the elastomeric material. The chain transfer agent can include, for example, an alkylmercaptan containing from 5 to 20 carbon atoms. The amount of the chain transfer agent in the recipe is generally in the range of from 0 weight percent to 5 weight percent and, in another embodiment, from 0 weight percent to 3 weight percent based on the entire weight of the elastomeric material. In the case where the amount exceeds 5 weight percent, the amount of the non-crosslinked portion in the rubber particle core increases, which may result in undesired effects on the heat resistance, rigidity, etc. of the composition when it is incorporated into an epoxy resin composition.

A polysiloxane type elastomer may be used in place of the elastomeric material described above as the rubber particle core or in combination therewith. In the case where the polysiloxane type elastomer is used as the rubber particle core, a polysiloxane type elastomer constituted of dialkyl or diaryl substituted silyloxy unit, for example, dimethyl silyloxy, methylphenyl silyloxy, and diphenyl silyloxy can be used. In an embodiment, when using such a polysiloxane type elastomer, a crosslinked structure can be introduced by using a polyfunctional alkoxy silane compound or with radial polymerization of silane compound having a vinylic reactive group.

In an embodiment, the polymer particles can be configured to have an intermediate layer between an elastic core layer and a shell layer. The intermediate layer is formed by using a monomer (hereinafter, sometimes referred to as a “monomer for intermediate layer formation”) having two or more polymerizable (radical polymerizable) double bonds in a single molecule. Through one of the double bonds, the monomer for intermediate layer formation is graft-polymerized with a polymer forming the elastic core layer to substantially chemically bond the intermediate layer and the shell layer and, at the same time, through the remaining double bond(s), crosslinking the surface of the elastic core layer. This can improve the grafting efficiency of the shell layer, since many double bonds are arranged in the elastic core layer.

In an embodiment, the intermediate layer is present in an amount of from 0.2 weight percent to 7 weight percent of the polymer particles. The monomer has two or more double bonds and can be selected from the group consisting of (meth)acrylate type polyfunctional monomers, isocyanuric acid derivatives, aromatic vinyl type polyfunctional monomers, and aromatic polycarboxylic acid esters. Radical polymerizable double bonds are more efficient to form a crosslinked layer that covers surface of the elastic core layer. The mass of the monomers forming the intermediate layer equals the mass of the intermediate layer, assuming all monomers added to the formulation participated in the reaction to form the intermediate layer.

The shell layer can provide the affinity to the rubbery polymer particles for the particles to be stably dispersed in the form of primary particles in the polyol component.

The polymer constituting the shell layer is graft polymerized with the polymer constituting the rubber particle core in an embodiment, substantially forming a chemical bond with the polymer constituting the core. For facilitating production of the composition containing the polyol component according to the production process of this invention, at least 70 weight percent in one embodiment, at least 80 weight percent in another embodiment, and at least 90 weight percent in yet another embodiment, of the polymer constituting the shell layer is bonded with the core.

In an embodiment, the shell layer has limited swellability, compatibility or affinity to the polyol component to facilitate mixing and dispersion of the rubbery polymer particles in the resins.

In another embodiment, the shell layer has non-reactive functional groups with epoxide, but optionally reactive functional groups capable of forming chemical bonds with epoxy hardeners, such as amines and anhydrides, under conditions where the epoxy resins react with the curing agents are also suitable.

In an embodiment, the polymer constituting the shell layer is a polymer or copolymer obtained by polymerizing or copolymerizing one or more ingredients selected from the group consisting of (meth)arcylic esters, aromatic vinyl compounds, vinyl cyanate compounds, unsaturated acid derivatives, (meth)acrylamide derivatives and maleimide derivatives. Particularly, in embodiments where chemical reactivity is required for the shell layer during curing of the epoxy composition, it is preferred to use a copolymer obtained by copolymerizing one or more of monomers containing one or more of reactive functional groups selected from carboxyl groups, hydroxyl groups, carbon-carbon double bonds, anhydride groups, amino groups or amide groups which can react with the epoxy composition, or a curing agent thereof, or a curing catalyst thereof, etc., in addition to alky(meth)arcylic esters, aromatic vinyl compounds or vinyl cyanate compounds. In an embodiment, the functional group is at least one reactive functional group selected from the group consisting of an epoxy group, a carboxyl group, an amino group, an anhydride group, a hydroxyl group, or a carbon-carbon double bond.

Examples of the (meth)arcylic esters that can be used include, but are not limited to alkyl(meth)acrylate esters such as methyl(meth)acrylate, ethyl(meth)acrylate, butyl(meth)acrylate, and 2-ethylhexyl(meth)acrylate. Examples of the aromatic vinyl compounds include, but are not limited to styrene, α-methylstyrene, alkyl-substituted styrene, and halogen-substituted styrenes such as bromo styrene or chloro styrene. Examples of vinyl cyanate compounds include, but are not limited to (meth)acrylonitrile and substituted acrylonitrile. Examples of the monomers containing the reactive functional group include, but are not limited to 2-hydroxylethyl(meth)acrylate, 2-aminoethyl(meth)acrylate, glycidyl(meth)acrylate, and (meth)acrylate esters having a reactive side chain. Examples of the vinyl ether containing a reactive group include but are not limited to glycidyl vinyl ether and allyl vinyl ether. Examples of the unsaturated carboxylic acid derivatives include but are not limited to (meth)acrylic acid, itaconic acid, chrotonic acid and maleic acid anhydride. Examples of (meth)acrylamide derivatives include, but are not limited to (meth)acrylamide (including N-substituted products). Examples maleimide derivatives include but are not limited to maleicacid imide (including N-substitution products).

The weight ratio of the core layer to the shell layer of a preferred rubber particle is generally in the range of from 40/60 to 95/5, in the range of 50/50 to 95/5 in another embodiment, and is in the range of from 60/40 to 85/15 in yet another embodiment. In a case where the core/shell weight ratio is outside of 40/60 and the amount of the rubber particle core layer is lower than that of the shell layer, then improvement in toughness of an epoxy thermoset containing the rubber particle dispersion tends to be lower. On the other hand, in cases where the ratio is outside of 95/5 and the amount of the shell layer is lower than that of the core layer, it can result in problems in the production process during coagulation and the expected properties may not be obtained.

The rubbery polymer particles (B) can be produced by a well-known method, for example, emulsion polymerization, suspension polymerization, or micro-suspension polymerization. Among them, a production process by the emulsion polymerization is suitable from the view point that it is easy to design composition of the rubbery polymer particles (B), and it is easy to produce the particles at an industrial scale and maintain quality of the rubbery polymer particles suitable to the process of this invention. As the emulsifying or dispersing agent in an aqueous medium, it is preferred to use those that maintain emulsifying or dispersion stability even in the case where pH of the aqueous latex is neutral. Specifically, they include, for example, nonionic emulsifier or dispersant such as alkali metal salts or ammonium salts of various acids, for example, alkyl or aryl sulfonic acids typically represented by dioctyl sulfosuccinic acid or dodecylbenzene sulfonic acid, alkyl or aryl sulfonic acid typically represented by dodecyl sulfonic acid, alkyl or aryl ether sulfonic acid, alkyl or aryl substituted phosphoric acid, alkyl or aryl ether substituted phosphoric acid, or N-alkyl or aryl sarcosinic acid typically represented by dodecyl sarcosinic acid, alkyl or aryl carboxylic acid typically represented by oleic acid or stearic acid, alkyl or aryl ether carboxylic acids, and alkyl or aryl substituted polyethylene glycol, and dispersant such as polyvinyl alcohol, alkyl substituted cellulose, polyvinyl pyrrolidone or polyacrylic acid derivative. They may be used alone or in combination of two or more.

Typically, the dispersion is as pure as possible, with no surfactants or processing additives. In some embodiments, optional components, such as air releasers may help with certain processing characteristics, but can also have detrimental effects to applications as well. In some embodiments, surfactants and processing additives are used in the emulsion polymerization step and are removed.

In another embodiment of the present invention, there is disclosed a composition comprising, consisting of, or consisting essentially of: a) an epoxy resin; b) a hardener; and c) the above-described toughener.

### Epoxy Resin

The epoxy resins used in the composition can vary and include conventional and commercially available epoxy resins, which can be used alone or in combinations of two or more, including, for example, novolac resins and isocyanate modified epoxy resins, among others. In choosing epoxy resins for compositions disclosed herein, consideration should not only be given to properties of the final product, but also to viscosity and other properties that may influence the processing of the resin composition.

The epoxy resin component can be any type of epoxy resin useful in molding compositions, including any material containing one or more reactive oxirane groups, referred to herein as “epoxy groups” or “epoxy functionality.” Epoxy resins useful in embodiments disclosed herein can include mono-functional epoxy resins, multi- or polyfunctional epoxy resins, and combinations thereof. Monomeric and polymeric epoxy resins can be aliphatic, cycloaliphatic, aromatic, or heterocyclic epoxy resins. The polymeric epoxies include linear polymers having terminal epoxy groups (a diglycidyl ether of a polyoxyalkylene glycol, for example), polymer skeletal oxirane units (polybutadiene polyepoxide, for example) and polymers having pendant epoxy groups (such as a glycidyl methacrylate polymer or copolymer, for example). The epoxies may be pure compounds, but are generally mixtures or compounds containing one, two or more epoxy groups per molecule. In an embodiment, the epoxy resin is prepared from a halogen-containing compound. Typically, the halogen is bromine. In some embodiments, epoxy resins can also include reactive —OH groups, which can react at higher temperatures with anhydrides, organic acids, amino resins, phenolic resins, or with epoxy groups (when catalyzed) to result in additional crosslinking. In an embodiment, the epoxy resin is produced by contacting a glycidyl ether with a bisphenol compound, such as, for example, bisphenol A or tetrabromobisphenol A to form epoxy-terminated oligomers. In another embodiment, the epoxy resins can be advanced by reaction with isocyanates to form oxazolidinones. Suitable oxazolidinones include toluene diisocyanate and methylene diisocyanate (MDI or methylene bis(phenylene isocyanate)).

The composition of the present invention can also be modified by addition of other thermosets and thermoplastics. Examples of other thermosets include but are not limited to cyanates, triazines, maleimides, benzoxazines, allylated phenols, and acetylenic compounds. Examples of thermoplastics include poly(aryl ethers) such as polyphenylene oxide, poly(ether sulfones), poly(ether imides) and related materials.

In general, the epoxy resins can be glycidylated resins, cycloaliphatic resins, epoxidized oils, and so forth. The glycidated resins are frequently the reaction product of a glycidyl ether, such as epichlorohydrin, and a bisphenol compound such as bisphenol A; C₄ to C₂₈ alkyl glycidyl ethers; C₂ to C₂₈ alkyl- and alkenyl-glycidyl esters; C₁ to C₂₈ alkyl-, mono- and poly-phenol glycidyl ethers; polyglycidyl ethers of polyvalent phenols, such as pyrocatechol, resorcinol, hydroquinone, 4,4′-dihydroxydiphenyl methane (or bisphenol F), 4,4′-dihydroxy-3,3′-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris(4-hydroxyphynyl)methane; polyglycidyl ethers of the chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether; polyglycidyl ethers of polyphenols obtained by condensing phenols and long-chain halogen paraffins containing at least two halogen atoms. Other examples of epoxy resins useful in embodiments disclosed herein include bis-4,4′-(1-methylethylidene) phenol diglycidyl ether and (chloromethyl) oxirane bisphenol A diglycidyl ether.

In some embodiments, the epoxy resin can include glycidyl ether type; glycidyl-ester type; alicyclic type; heterocyclic type, and halogenated epoxy resins, etc. Non-limiting examples of suitable epoxy resins can include cresol novolac epoxy resin, phenolic novolac epoxy resin, biphenyl epoxy resin, hydroquinone epoxy resin, stilbene epoxy resin, and mixtures and combinations thereof.

Suitable polyepoxy compounds can include resorcinol diglycidyl ether (1,3-bis-(2,3-epoxypropoxyl)benzene), diglycidyl ether of bisphenol A (2,2-bis(p-(2,3-epoxypropoxyl)phenyl)propane), triglycidyl p-aminophenol (4-(2,3-epoxypropoxy)-N,N-bis(2,3-epoxypropyl)aniline), diglycidyl ether of bromobispehnol A (2,2-bis(4-(2,3-epoxypropoxy)3-bromo-phenyl)propane), diglydicylether of bisphenol F (2,2-bis(p-(2,3-epoxypropoxyl)phenyl)methane), triglycidyl ether of meta- and/or para-aminophenol (3-(2,3-epoxypropoxy)N,N-bis(2,3-epoxypropyl)aniline), and tetraglycidyl methylene dianiline (N,N,N′,N′-tetra(2,3-epoxypropyl) 4,4′-diaminodiphenyl methane), and mixtures of two or more polyepoxy compounds. A more exhaustive list of useful epoxy resins found can be found in Lee, H. and Neville, K., Handbook of Epoxy Resins, McGraw-Hill Book Company, 1982 reissue.

Other suitable epoxy resins include polyepoxy compounds based on aromatic amines and epichlorohydrin, such as N,N′-diglycidyl-aniline; N,N′-dimethyl-N,N′-diglycidyl-4,4′-diaminodiphenyl methane; N,N,N′,N′-tetraglycidyl-4,4′-diaminodiphenyl methane; N-diglycidyl-4-aminophenyl glycidyl ether; and N,N,N′,N′-tetraglycidyl-1,3-propylene bis-4-aminobenzoate. Epoxy resins can also include glycidyl derivatives of one or more of: aromatic diamines, aromatic monoprimary amines, aminophenols, polyhydric phenols, polyhydric alcohols, polycarboxylic acids.

Useful epoxy resins include, for example, polyglycidyl ethers of polyhydric polyols, such as ethylene glycol, triethylene glycol, 1,2-propylene glycol, 1,5-pentanediol, 1,2,6-hexanetriol, glycerol, and 2,2-bis(4-hydroxy cyclohexyl)propane; polyglycidyl ethers of aliphatic and aromatic polycarboxylic acids, such as, for example, oxalic acid, succinic acid, glutaric acid, terephthalic acid, 2,6-napthalene dicarboxylic acid, and dimerized linoleic acid; polyglycidyl ethers of polyphenols, such as, for example, bisphenol A, bisphenol F, 1,1-bis(4-hydroxyphenyl)ethane, 1,1-bis(4-hydroxyphenyl)isobutane, and 1,5-dihydroxy napthalene; modified epoxy resins with acrylate or urethane moieties; glycidlyamine epoxy resins; and novolac resins.

The epoxy compounds can be cycloaliphatic or alicyclic epoxides. Examples of cycloaliphatic epoxides include diepoxides of cycloaliphatic esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl)adipate, bis(3,4-epoxycyclohexylmethyl)pimelate; vinylcyclohexene diepoxide; limonene diepoxide; dicyclopentadiene diepoxide; and the like. Other suitable diepoxides of cycloaliphatic esters of dicarboxylic acids are described, for example, in U.S. Pat. No. 2,750,395.

Other cycloaliphatic epoxides include 3,4-epoxycyclohexylmethyl-3,4-epoxycyclohexane carboxylates such as 3,4-epoxycyclohexylmethyl-3,4-epoxycyclohexane carboxylate; 3,4-epoxy-1-methylcyclohexyl-methyl-3,4-epoxy-1-methylcyclohexane carboxylate; 6-methyl-3,4-epoxycyclohexylmethylmethyl-6-methyl-3,4-epoxycyclohexane carboxylate; 3,4-epoxy-2-methylcyclohexylmethyl-3,4-epoxy-2-methylcyclohexane carboxylate; 3,4-epoxy-3-methylcyclohexyl-methyl-3,4-epoxy-3-methylcyclohexane carboxylate; 3,4-epoxy-5-methylcyclohexyl-methyl-3,4-epoxy-5-methylcyclohexane carboxylate and the like. Other suitable 3,4-epoxycyclohexylmethyl-3,4-epoxycyclohexane carboxylates are described, for example, in U.S. Pat. No. 2,890,194.

Further epoxy-containing materials which are useful include those based on glycidyl ether monomers. Examples are di- or polyglycidyl ethers of polyhydric phenols obtained by reacting a polyhydric phenol, such as a bisphenol compound with an excess of chlorohydrin such as epichlorohydrin. Such polyhydric phenols include resorcinol, bis(4-hydroxyphenyl)methane (known as bisphenol F), 2,2-bis(4-hydroxyphenyl)propane (known as bisphenol A), 2,2-bis(4′-hydroxy-3′,5′-dibromophenyl)propane, 1,1,2,2-tetrakis(4′-hydroxy-phenyl)ethane or condensates of phenols with formaldehyde that are obtained under acid conditions such as phenol novolacs and cresol novolacs. Examples of this type of epoxy resin are described in U.S. Pat. No. 3,018,262. Other examples include di- or polyglycidyl ethers of polyhydric alcohols such as 1,4-butanediol, or polyalkylene glycols such as polypropylene glycol and di- or polyglycidyl ethers of cycloaliphatic polyols such as 2,2-bis(4-hydroxycyclohexyl)propane. Other examples are monofunctional resins such as cresyl glycidyl ether or butyl glycidyl ether.

Another class of epoxy compounds are polyglycidyl esters and poly(beta-methylglycidyl) esters of polyvalent carboxylic acids such as phthalic acid, terephthalic acid, tetrahydrophthalic acid or hexahydrophthalic acid. A further class of epoxy compounds are N-glycidyl derivatives of amines, amides and heterocyclic nitrogen bases such as N,N-diglycidyl aniline, N,N-diglycidyl toluidine, N,N,N′,N′-tetraglycidyl bis(4-aminophenyl)methane, triglycidyl isocyanurate, N,N′-diglycidyl ethyl urea, N,N′-diglycidyl-5,5-dimethylhydantoin, and N,N′-diglycidyl-5-isopropylhydantoin.

Still other epoxy-containing materials are copolymers of acrylic acid esters of glycidol such as glycidylacrylate and glycidylmethacrylate with one or more copolymerizable vinyl compounds. Examples of such copolymers are 1:1 styrene-glycidylmethacrylate, 1:1 methyl-methacrylateglycidylacrylate and a 62.5:24:13.5 methylmethacrylate-ethyl acrylate-glycidylmethacrylate.

Epoxy compounds that are readily available include octadecylene oxide; glycidylmethacrylate; diglycidyl ether of bisphenol A; D.E.R.™ 331 (bisphenol A liquid epoxy resin) and D.E.R.™ 332 (diglycidyl ether of bisphenol A) available from The Dow Chemical Company, Midland, Mich.; vinylcyclohexene dioxide; 3,4-epoxycyclohexylmethyl-3,4-epoxycyclohexane carboxylate; 3,4-epoxy-6-methylcyclohexyl-methyl-3,4-epoxy-6-methylcyclohexane carboxylate; bis(3,4-epoxy-6-methylcyclohexylmethyl) adipate; bis(2,3-epoxycyclopentyl) ether; aliphatic epoxy modified with polypropylene glycol; dipentene dioxide; epoxidized polybutadiene; silicone resin containing epoxy functionality; flame retardant epoxy resins (such as a brominated bisphenol type epoxy resin available under the trade names D.E.R.™ 530, 538, 539, 560, 592, and 593, available from The Dow Chemical Company, Midland, Mich.); polyglycidyl ether of phenolformaldehyde novolac (such as those available under the tradenames D.E.N.™ 431, D.E.N.™ 438, and D.E.N.™ 439 available from The Dow Chemical Company, Midland, Mich.); and resorcinol diglycidyl ether. Other examples include D.E.R.™ 383, D.E.R.™ 6508, D.E.R.™ 661, D.E.R.™ 671, D.E.R.™ 664, D.E.R.™ 6510, EPON™ 820, EPON™ 821, EPON™ 826, EPON™ 828, and the like, and mixtures thereof.

In an embodiment, the epoxy resin can be produced by contacting a glycidyl ether with a bisphenol compound and a polyisocyanate, such as toluene diisocyanate or ‘methylene diisocyanate’ (the diisocyanate of methylene dianiline), to form oxazolidinone moieties.

### Hardener

Any suitable epoxy hardener can be used. Examples of epoxy hardeners that can be used include, but are not limited to aliphatic amines, modified aliphatic amines, cycloaliphatic amines, modified cycloaliphatic amines, amidoamines, polyamide, tertiary amines, aromatic amines, anhydrides, mercaptans, cyclic amidines, isocyanates cyanate esters, and the like. Suitable hardeners include Bis(4-aminocyclohexyl)methane (AMICURE® PACM), diethylenetriamine (DETA), triethylenetetramine (TETA), aminoethylpiperazine (AEP), isophorone diamine (IPDA), 1,2-diaminocyclohexane (DACH), 4,4′-diaminodiphenylmethane (MDA), 4,4′-diaminodiphenylsulfone (DDS), m-phenylenediamine (MPD), diethyltoluenediamine (DETDA), metda-xylene diamine (MXDA), bis(aminomethyl cyclohexane), dicyandiamide, phthalic anhydride (PA), tetrahydrophthalic anhydride (THPA), methyltetrahydrophthalic anhydride (MTHPA), methyl hexahydrophthalic anhydride (MHHPA), hexahydrophthalic anhydride (HHPA), nadic methyl anhydride (NMA), benzophenonetetracarboxylic dianhydride (BTDA), tetrachlorophthalic anhydride (TCPA), and the like, and mixtures thereof.

### Toughener

In an embodiment, the toughener used in this composition comprises a) 45 to 97 weight percent of a divinylarene dioxide; and b) 3 to 55 weight percent of a core shell rubber, as described above.

### Optional Components

Optionally, catalysts may be added to the curable compositions described above. Catalysts may include, but are not limited to, imidazole compounds including compounds having one imidazole ring per molecule, such as imidazole, 2-methylimidazole, 2-ethyl-4-methylimidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 1-cyanoethyl-2-methylimidazole, 1-cyanoethyl-2-ethyl-4-methylimidazole, 1-cyanoethyl-2-undecylimidazole, 1-cyanoethyl-2-isopropylimidazole, 1-cyanoethyl-2-phenylimidazole, 2,4-diamino-6-[2′-methylimidazolyl-(1)′]-ethyl-s-triazine, 2,4-diamino-6-[2′-ethyl-4-methylimidazolyl-(1)′]-ethyl-s-triazine, 2,4-diamino-6-[2′-undecylimidazolyl-(1)′]-ethyl-s-triazine, 2-methyl-imidazo-lium-isocyanuric acid adduct, 2-phenylimidazolium-isocyanuric acid adduct, 1-aminoethyl-2-methylimidazole, 2-phenyl-4,5-dihydroxymethylimidazole, 2-phenyl-4-methyl-5-hydroxymethylimidazole, 2-phenyl-4-benzyl-5-hydroxymethylimidazole and the like; and compounds containing 2 or more imidazole rings per molecule which are obtained by dehydrating above-named hydroxymethyl-containing imidazole compounds such as 2-phenyl-4,5-dihydroxymethylimidazole, 2-phenyl-4-methyl-5-hydroxymethylimidazole and 2-phenyl-4-benzyl-5-hydroxy-methylimidazole; and condensing them with formaldehyde, e.g., 4,4′-methylene-bis-(2-ethyl-5-methylimidazole), and the like.

In other embodiments, suitable catalysts may include amine catalysts such as N-alkylmorpholines, N-alkylalkanolamines, N,N-dialkylcyclohexylamines, and alkylamines where the alkyl groups are methyl, ethyl, propyl, butyl and isomeric forms thereof, and heterocyclic amines.

Other optional components can include defoamers and leveling agents.

### Process for Producing the Composition

In an embodiment of the invention, there is disclosed a process for preparing the above-mentioned composition comprising, consisting of, or consisting essentially of dispersing a core shell rubber into a divinylarene dioxide component with a high shear mixer in a dispersion zone under dispersion conditions wherein said dispersion zone does not contain a solvent and wherein said dispersion conditions comprise a dispersion temperature of 40° C. to 100° C., a Reynolds Number greater than 10, and a dispersion time of from 30 minutes to 300 minutes.

The core shell rubber is dispersed into a divinylarene dioxide component with a high shear mixer in a dispersion zone. The high speed mixer is generally equipped with a variable speed control, a temperature probe and a cowles mixing blade or variations of a cowles. To achieve the best mixing results, the diameter of the cowles mixing blade (D) is generally between 0.2 to 0.7 of the diameter of the vessel (T) (D/T=0.2˜0.7), between 0.25˜0.50 in another embodiment, and between 0.3 to 0.4 in yet another embodiment. The blade clearance from the bottom of the vessel is generally from 0.2D to 2.0D, from 0.4D to 1.5D in another embodiment, and from 0.5D to 1.0D in yet another embodiment. The height of the mixture (H) is generally between 1.0D to 2.5D, between 1.25D to 2.0D in another embodiment, and 1.5D to 1.8D in yet another embodiment. The dispersion zone does not contain a solvent. The dispersion zone generally has a dispersion temperature in the range of from 0° C. to 110° C. The dispersion zone has a dispersion temperature in the range of from 25° C. to 90° C. in another embodiment, and a dispersion temperature in the range of from 60° C. to 80° C. in yet another embodiment.

The Reynolds number is a measure of the ratio of inertial forces to viscous forces. Generally, the dispersion zone is maintained at a Reynolds number of greater than 10. The dispersion zone is maintained at a Reynolds number of greater than 100 in another embodiment and is maintained at a Reynolds number of greater than 300 in yet another embodiment.

The dispersion zone is maintained at the dispersion conditions for as long as necessary to achieve a uniform, single/discrete particle dispersion. In an embodiment, the dispersion zone is maintained at the dispersion conditions for a time in the range of 30 minutes to 180 minutes. In an embodiment, a vacuum can be applied to remove any entrapped air.

The dispersion zone can also contain a dispersing agent. Examples of dispersing agents include, but are not limited to nonionic emulsifiers or dispersants such as alkali metal salts or ammonium salts of various acids, for example, alkyl or aryl sulfonic acids typically represented by dioctyl sulfosuccinic acid or dodecylbenzene sulfonic acid, alkyl or aryl sulfonic acid typically represented by dodecyl sulfonic acid, alkyl or aryl ether sulfonic acid, alkyl or aryl substituted phosphoric acid, alkyl or aryl ether substituted phosphoric acid, or N-alkyl or aryl sarcosinic acids typically represented by dodecyl sarcosinic acid, alkyl or aryl carboxylic acid typically represented by oleic acid or stearic acid, alkyl or aryl ether carboxylic acids, and alkyl or aryl substituted polyethylene glycols, and dispersants such as polyvinyl alcohols, alkyl substituted cellulose, polyvinyl pyrrolidones or polyacrylic acid derivatives. They may be used alone or in combinations of two or more.

In an embodiment, the dispersion formed by this process contain 5 weight percent to 45 weight percent of polymer particles. The dispersion formed contains 15 weight percent to 40 weight percent of polymer particles in another embodiment, and contain 25 weight percent to 35 weight percent of polymer particles in yet another embodiment.

### Preparation and Curing

In an embodiment composition comprising a) an epoxy resin; b) a hardener; and c) the above-described toughener is made by mixing using any standard mixing techniques known in the art.

Generally, the compositions can be UV cured with or without photo initiators or thermal cured with or without a catalyst. In an embodiment, the thermal curing is completed in multiple steps, with the first step at a temperature less than 120° C. for at least 1 hour. The composition can be processed according to any suitable processing technology, such as filament winding, pultrusion, resin transfer molding, vacuum assisted resin transfer molding, and pre-preg.

### End Use Applications

The composition can be used for advanced composites, electronics, coatings and structural adhesives. Examples of advanced composites include but are not limited to aerospace composites, automotive composites, and composites useful in the sports and recreation industries. Typical electronic applications include but are not limited to electronic adhesives, electrical laminates, and electrical encapsulations. The composition can also be used for pipe coatings used in, for example, the oil and gas industry.

### Examples

### Raw Materials

PARALOID™ EXL 2650A: Core shell rubber particles based on butadiene core. Supplied by the Dow Chemical Company

PARALOID™ EXL 5766: Core shell rubber particles based on butylacrylate core with particle size at 850 nm. Supplied by the Dow Chemical Company

Divinylbenzene dioxide Supplied by the Dow Chemical Company

D.E.R.™ 383 Diglycidyl ether of bisphenol A, supplied by the Dow Chemical Company

D.E.N.™ 438 Reaction product of epichlorohydrin and phenol-formaldehyde novolac, supplied by the Dow Chemical Company

BDDGE 1,4 butanediol diglycidyl ether, supplied by The Dow Chemical Company

IPDA: Isophorone diamine, supplied by BASF

MTHPA: Methyltetrahydrophthalic anhydride, supplied by Dixie Chemical Company

NMA: Nadic methyl anhydride, supplied by Dixie Chemical Company

Ancamine DL 50 4,4′-Diaminodiphenylmethane, supplied by Air Products

### Dispersion Example 1

450 grams of divinylbenzene dioxide at room temperature was added to a 1 QT open top metal container. The container was then placed under a high shear disperser equipped with a 50 mm diameter Cowles mixer, a variable speed control and a temperature monitor. The Cowles mixer was lowered to allow it to be immersed in the liquid. The height of the mixer to the bottom of the container was kept at 25˜50 mm 150 grams of PARALOID™ EXL 2650A were added to the container gradually while the mixer was running at 1500 rpm. The mixing speed was increased to 2000 rpm after addition of the core shell rubber particles. The Reynolds Number (N_{RE}) at the mixing conditions is reported in Table 1. N_{RE}=D²Nρ/μ, where D is the impeller diameter, N is the revolutions per second of the impeller, ρ is the density of the liquid and μ is the viscosity of the liquid.

After mixing for 75 minutes, a uniform, low viscosity, off-white dispersion was achieved. The temperature of the dispersion was measured with a thermometer and is reported in Table 1. The quality of the dispersion was evaluated by Hegmen grind and microscopy. No agglomeration of the particles was observed. The viscosity of the dispersion was measured by an AR2000 Rheometer made by the TA Instruments. Measurements were conducted at 10 Hz as the temperature was ramped from 30° C. to 80° C. at 3° C./minute. Results are reported in Table 1.

### Dispersion Example 2

390 grams of divinylbenzene dioxide was mixed with 210 grams of PARALOID™ EXL 2650A using the same mixing parameters as described in Dispersion Example 1. The Reynolds Number was 415 at 25° C. After mixing for 75 minutes, a uniform, low viscosity dispersion was achieved. Temperature of the dispersion was measured and is reported in Table 1. No agglomeration was observed under Hegmen grind and microscopy. The viscosity of the dispersion is reported in Table 1.

### Dispersion Example 3

90 grams of divinylbenzene dioxide and 360 grams of D.E.R.™ 383 were mixed first at room temperature at 1000 rpm for 15 minutes using the disperser described in Dispersion Example 1. After a homogeneous mixture was achieved, 150 grams of PARALOID™ EXL 2650A was dispersed in the liquid using the same mixing parameters as described in Dispersion Example 1. The Reynolds Number was 6800 at 25° C. After mixing for 75 minutes, a uniform, low viscosity dispersion was achieved. The temperature of the dispersion was measured and is reported in Table 1. No agglomeration was observed under Hegmen grind and microscopy. The viscosity of the dispersion is reported in Table 1.

### Dispersion Example 4

90 grams of divinylbenzene dioxide was mixed with 360 grams of D.E.N.™ 438 preconditioned at 60° C. overnight at 1000 rpm for 15 minutes using the disperser described in Dispersion Example 1. After a homogenous mixture was achieved, 150 grams of PARALOID™ EXL 2650A was dispersed in the mixture using the mixing parameters described in Dispersion Example 1. The Reynolds Number was 685 at 25° C. After mixed for 75 minutes, a uniform, low viscosity dispersion was achieved. The temperature of the dispersion was measured and is reported in Table 1. No agglomeration was observed under Hegmen grind and microscopy. The viscosity of the dispersion is reported in Table 1.

### Comparative Dispersion Example 1

450 grams of D.E.R.™ 383 preconditioned at 50° C. was added to a 1 QT open top metal container. The container was then placed under a high shear mixer equipped with a 50 mm diameter Cowles mixer, a variable speed control and a temperature monitor. The Cowles mixer was lowered to allow it to be immersed in the liquid. The height of the mixer to the bottom of the container was kept at 25 to 50 mm 150 grams of PARALOID™ EXL 2650A were added to the container gradually while the mixer was running at 1500 rpm. The mixing speed was increased to 2500 rpm after addition of the core shell rubber particles. After mixing for 75 minutes, a uniform, high viscosity, white dispersion was achieved. Temperature and viscosity of the dispersion were measured and are reported in Table 1. Quality of the dispersion was evaluated by Hegmen grind and microscopy. No agglomeration of the particles was observed.

### Comparative Dispersion Example 2

390 grams of BDDGE at room temperature were added to a 1 QT open top metal container. The container was then placed under a high shear mixer equipped with a 50 mm diameter Cowles mixer, a variable speed control and a temperature monitor. The Cowles mixer was lowered to allow it to be immersed in the liquid. The height of the mixer to the bottom of the container was kept at 25˜50 mm 210 grams of PARALOID′ EXL 2650A were added to the container gradually while the mixer was running at 1500 rpm. The mixing speed was increased to 2000 rpm after addition of the core shell rubber particles. After mixing for 75 minutes, a uniform, high viscosity, white dispersion was achieved. Temperature and viscosity of the dispersion were measured and are reported in Table 1. Quality of the dispersion was evaluated by Hegmen grind and microscopy. No agglomeration of the particles was observed.

### Comparative Dispersion Example 3

300 grams of divinylbenzene dioxide at room temperature was added to a 1 QT open top metal container. The container was then placed under a high shear mixer equipped with a 50 mm diameter Cowles mixer, a variable speed control and a temperature monitor. The Cowles mixer was lowered to allow it to be immersed in the liquid. The height of the mixer to the bottom of the container was kept at 25˜50 mm 100 grams of PARALOID™ EXL 5766 was then added to the container gradually while the mixer was running at 2500 rpm. The mixture became a high viscosity paste after the PARALOID™ EXL 5766 was added. The material was not flowable under the mixing conditions. Granulate particles were observed in the paste. A large agglomeration of particles in the paste was observed using Hegmen grind. The dispersion did not meet the minimum quality standard.

### Comparative Dispersion Example 4

300 grams of divinylbenzene dioxide at room temperature was added to a 1 QT open top metal container. The container was then placed under a high shear mixer equipped with a 50 mm diameter Cowles mixer, a variable speed control and a temperature monitor. The Cowles mixer was lowered to allow it to be immersed in the liquid. The height of the mixer to the bottom of the container was kept at 25˜50 mm 52.9 grams of PARALOID™ EXL 5766 was then added to the container gradually while the mixer was running at 2500 rpm. After mixing for 75 minutes, the mixture turned into a viscous liquid with viscosity of 2500 cps at 30° C. No agglomeration of particles was observed using Hegmen grind. However, after storing at room temperature for about two weeks, a skin had surprisingly formed on the top of the mixture, indicating a lack of stability for the dispersion. This dispersion is considered less desirable due to poor stability.

### PLAQUE EXAMPLES

The plaque examples are formulated as described below. After conditioning at room temperature for about 2 weeks, the plaques are machined into the appropriate test specimens for measuring fracture toughness and glass transition temperature (T_{g}). Fracture toughness was measured according to ASTM D5045, and glass transition temperature was measured by Dynamic Mechanical Analysis (DMA) at 3° C./min and 0.05% strain on an ARES Rheometer from TA Instruments. Results for the plaque examples are reported in Table 2.

### Plaque Example 1

185 grams of D.E.R.™ 383 and 68.5 grams of Dispersion Example 2 were mixed first via a Speedmixer™ by Hauschild at 2200 rpm for 1 minute. 66.56 grams of IPDA were added to the mixing cup subsequently. After mixing at 2200 rpm for 2 minutes, the mixture was placed in a vacuum chamber to remove any entrapped air. Once the mixture was fully degassed, it was poured into a mold to form a 3.25 mm thick plaque. The mold was immediately placed in a forced air convection oven and cured at 90° C. for 2 hours, followed by 4 hours at 165° C. before it was cooled to room temperature slowly.

### Comparative Plaque Example 1

259.2 grams of D.E.R.™ 383 and 60.8 grams of IPDA were added to a mixing cup. After mixing at 2200 rpm for 2 minutes with a Speedmixer™ by Hauschild, the mixture was placed in a vacuum chamber to remove any entrapped air. Once the mixture was fully degassed, it was poured into a mold to form a 3.25 mm thick plaque. The mold was immediately placed in a forced air convection oven and cured at 90° C. for 2 hours, followed by 4 hours at 165° C. before it was cooled to room temperature slowly.

### Comparative Plaque Example 2

192 grams of D.E.R.™ 383 and 68.48 grams of Comparative Dispersion Example 2 were first mixed at 2200 rpm for 2 minutes with a Speedmixer™ by Hauschild. 59.52 grams of IPDA were then added to the mixture. After mixing at 2200 rpm for 2 minutes with the Speedmixer™, the mixture was placed in a vacuum chamber to remove any entrapped air. Once the mixture was fully degassed, it was pour into a mold to form a 3.25 mm thick plaque. The mold was immediately placed in a forced air convection oven and cured at 90° C. for 2 hours, followed by 4 hours at 165° C. before it was cooled to room temperature slowly.

### Plaque Example 2

167.5 grams of D.E.R.™ 383 and 68.54 grams of Dispersion Example 2 were mixed first via a Speedmixer™ by Hauschild at 2200 rpm for 1 minute. 56.29 grams of DL 50 were then added to the mixing cup. After mixing at 2200 rpm for 2 minutes, the mixture was placed in a vacuum chamber to remove any entrapped air. Once the mixture was fully degassed, it was poured into a mold to form a 3.25 mm thick plaque. The mold was immediately placed in a forced air convection oven and cured at 90° C. for 2 hours, followed by 4 hours at 150° C. before being cooled to room temperature slowly.

### Comparative Plaque Example 3

167.5 grams of D.E.R.™ 383 and 68.54 grams of Comparative Dispersion Example 2 were mixed first via a Speedmixer™ by Hauschild at 2200 rpm for 1 minute. 56.29 grams of DL 50 were then added to the mixing cup. After mixing at 2200 rpm for 2 minutes, the mixture was placed in a vacuum chamber to remove any entrapped air. Once the mixture was fully degassed, it was pour into a mold to form a 3.25 mm thick plaque. The mold was immediately placed in a forced air convection oven and cured at 90° C. for 2 hours, followed by 4 hours at 150° C. before it was cooled to room temperature slowly.

### Comparative Plaque Example 4

249.66 grams of D.E.R.™ 383 and 70.34 grams of Ancamine DL 50 were mixed via a Speedmixer™ by Hauschild at 2200 rpm for 2 minutes. The mixture was then placed in a vacuum chamber to remove any entrapped air. Once the mixture was fully degassed, it was poured into a mold to form a 3.25 mm thick plaque. The mold was immediately placed in a forced air convection oven and cured at 90° C. for 2 hours, followed with 4 hours at 150° C. before it was slowly cooled to room temperature.

### Plaque Example 3

88.38 grams of D.E.R.™ 383 and 68.74 grams of Dispersion Example 2 were mixed first via a Speedmixer™ by Hauschild at 2200 rpm for 1 minute. 162.88 grams of methyltetrahydrophthalic anhydride and 3.2 grams of 1-methylimidazole were added subsequently. After mixing at 2200 rpm for 2 minutes with the Speedmixer™, the mixture was placed in a vacuum chamber to remove any entrapped air. Once the mixture was fully degassed, it was poured into a mold to form a 3.25 mm thick plaque. The mold was immediately placed in a forced air convection oven and cured at 90° C. for 2 hours, followed by 4 hours at 165° C. before it was cooled to room temperature slowly.

### Comparative Plaque Example 5

105.3 grams of D.E.R.™ 383 and 68.74 grams of Comparative Dispersion Example 2 were mixed first via a Speedmixer™ by Hauschild at 2200 rpm for 1 minute. 145.95 grams of methyltetrahydrophthalic anhydride and 3.2 grams of 1 methylimidazole were added subsequently. After mixing at 2200 rpm for 2 minutes, the mixture was then placed in a vacuum chamber to remove any entrapped air. Once the mixture was fully degassed, it was pour into a mold to form a 3.25 mm thick plaque. The mold was immediately placed in a forced air convection oven and cured at 90° C. for 2 hours, followed by 4 hours at 165° C. before it was cooled to room temperature slowly.

### Comparative Plaque Example 6

171.01 grams of D.E.R.™ 383, 148.99 grams of methyltetrahydrophthalic anhydride and 3.2 grams of 1-methylimidazole were mixed via a Speedmixer™ by Hauschild at 2200 rpm for 2 minutes. The mixture was then placed in a vacuum chamber to remove any entrapped air. Once the mixture was fully degassed, it was poured into a mold to form a 3.25 mm thick plaque. The mold was immediately placed in a forced air convection oven and cured at 90° C. for 2 hours, followed by 4 hours at 165° C. before it was cooled to room temperature slowly.

### Plaque Example 4

82.3 grams of D.E.R.™ 383 and 68.7 grams of Dispersion Example 2 were mixed first via a Speedmixer™ by Hauschild at 2200 rpm for 1 minute. 168.96 grams of nadic methyl anhydride and 3.2 grams of 1-methylimidazole were then added to the mixing cup. After mixing at 2200 rpm for 2 minutes, the mixture was placed in a vacuum chamber to remove any entrapped air. Once the mixture was fully degassed, it was poured into a mold to form a 3.25 mm thick plaque. The mold was immediately placed in a forced air convection oven and cured at 90° C. for 2 hours, followed with 4 hours at 175° C. before it was cooled to room temperature slowly.

### Comparative Plaque Example 7

99.9 grams of D.E.R.™ 383 and 68.70 grams of Comparative Dispersion Example 2 were mixed first via a Speedmixer™ by Hauschild at 2200 rpm for 1 minute. 151.42 grams of nadic methyl anhydride and 3.2 grams of 1-methylimidazole were then added to the mixing cup. After mixing at 2200 rpm for 2 minutes, the mixture was then placed in a vacuum chamber to remove any entrapped air. Once the mixture was fully degassed, it was poured into a mold to form a 3.25 mm thick plaque. The mold was immediately placed in a forced air convection oven and cured at 90° C. for 2 hours, followed by 4 hours at 175° C. before it was cooled to room temperature slowly.

### Comparative Plaque Example 8

161.31 grams of D.E.R.™ 383 and 158.66 grams of nadic methyl anhydride and 3.2 grams of 1-methylimidazole were mixed via a Speedmixer™ by Hauschild at 2200 rpm for 2 minutes. The mixture was then placed in a vacuum chamber to remove any entrapped air. Once the mixture was fully degassed, it was poured into a mold to form a 3.25 mm thick plaque. The mold was immediately placed in a forced air convection oven and cured at 90° C. for 2 hours, followed by 4 hours at 175° C. before it was cooled to room temperature slowly.

### Comparative Plaque Example 9

86.08 grams of D.E.R.™ 383 and 96.096 grams of Comparative Dispersion Example 1 were mixed first via a Speedmixer™ by Hauschild at 2200 rpm for 1 minute. 137.82 grams of methyltetrahydrophthalic anhydride and 3.2 grams of 1-methylimidazole were then added to the mixing cup. After mixing at 2200 rpm for 2 minutes, the mixture was placed in a vacuum chamber to remove any entrapped air. Once the mixture was fully degassed, it was poured into a mold to form a 3.25 mm thick plaque. The mold was immediately placed in a forced air convection oven and cured at 90° C. for 2 hours, followed by 4 hours at 150° C. before it was cooled to room temperature slowly.

### Comparative Plaque Example 10

165.44 grams of D.E.R.™ 383 and 154.56 grams of nadic methyl anhydride and 3.2 grams of 1-methylimidazole were mixed via a Speedmixer™ by Hauschild at 2200 rpm for 2 minutes. The mixture was then placed in a vacuum chamber to remove any entrapped air. Once the mixture was fully degassed, it was poured into a mold to form a 3.25 mm thick plaque. The mold was immediately placed in a forced air convection oven and cured at 90° C. for 2 hours, followed by 4 hours at 175° C. before it was cooled to room temperature slowly.

TABLE 1
Properties of Dispersion Examples

| | Liquid | | | | Dispersion |
|---|---|---|---|---|---|
| | Viscosity @ | | N_{RE}, | N_{RE}, | Viscosity @ |
| | 30° C., | Density, | 1500 | 2500 | 30° C., |
| Example | mPa · S | g/cm³ | rpm | rpm | mPa · S |
| Dispersion | 12 | 1.00 | 5208 | 8681 | 770 |
| Example 1 | | | | | |
| Dispersion | 12 | 1.00 | 5208 | 8681 | 6843 |
| Example 2 | | | | | |
| Dispersion | 1230 | 1.13 | 57 | 96 | 25100 |
| Example 3 | | | | | |
| Dispersion | 10000 | 1.18 | 7 | 12 | 51830 |
| Example 4 | | | | | |
| Comparative | 4600 | 1.16 | 16 | 26 | 75570 |
| Dispersion | | | | | |
| Example 1 | | | | | |
| Comparative | 14 | 1.10 | 4910 | 8184 | 3970 |
| Dispersion | | | | | |
| Example 2 | | | | | |

At 25 to 35 weight percent loading, the viscosity of core shell rubber dispersions in divinylbenzene dioxide is low compared to dispersions of the same core shell rubber particles in liquid epoxy resin (LER) (Comparative Dispersion Example 1).

At 25 weight percent loading, the viscosity of the core shell rubber dispersion in the blend of D.E.R.™ 383 containing 20 weight percent divinylbenzene dioxide is significantly lower than dispersion of the same CSR in D.E.R.™ 383 (Comparative Dispersion Example 1).

At 25 weight percent loading, the viscosity of the core shell rubber dispersion in the blend of D.E.N.™ 438 containing 20 weight percent divinylbenzene dioxide is significantly lower than dispersion of the same CSR in D.E.R.™ 383 (Comparable Dispersion Example 1)

While viscosity of the dispersion of the CSR in BDDGE is low, it has a negative impact to the properties shown in Table 2.

TABLE 2
Fracture Toughness and Thermo Properties of the Examples

| | | Fracture | Flex | Tensile |
|---|---|---|---|---|
| | Tg, | Toughness, K1c, | Modulus, | Modulus, |
| Example | ° C. | mPa · m^{0.5} | MPa | MPa |
| Plaque Example 1 | 179 | 1.07 ± 0.04 | 3037 | 3053 |
| Comparative | 134 | 1.49 ± 0.05 | 2366 | 2738 |
| Plaque Example 1 | | | | |
| Comparative | 164 | 0.69 ± 0.05 | 2842 | 3021 |
| Plaque Example 2 | | | | |
| Plaque Example 2 | 181 | 1.05 ± 0.07 | 3120 | 3129 |
| Comparative | 160 | 0.86 ± 0.05 | 2583 | 2789 |
| Plaque Example 4 | | | | |
| Comparative | 171 | 0.77 ± 0.08 | 3025 | 3033 |
| Plaque Example 5 | | | | |
| Plaque Example 3 | 157 | 1.04 ± 0.07 | 2951 | 2935 |
| Comparative | 117 | 2.1-2.2 | 2344 | 2784 |
| Plaque Example 6 | | | | |
| Comparative | 142 | 0.54 ± 0.09 | 3061 | 3117 |
| Plaque Example 7 | | | | |
| Plaque Example 4 | 192 | 1.51 ± 0.09 | 2980 | 2987 |
| Comparative | 144 | 1.08-2.81 | 2529 | 2708 |
| Plaque Example 8 | | | | |
| Comparative | 170 | 0.49 ± 0.09 | 3147 | 3365 |
| Plaque Example 9 | | | | |
| Comparative | 143 | 1.89 ± 0.12 | 2701 | 2692 |
| Plaque Example 10 | | | | |

Incorporation of core shell rubber dispersions of divinylbenzene dioxide can significantly improve fracture toughness and thermal stability of the epoxy network, as is evident by the increase in glass transition temperature and K1c comparing to the controls that do not contain core shell rubber particles. In addition, modulus slightly increased in amine cured thermosets, and only minor decrease in modulus was observed in anhydride cured system.

Incorporation of core shell rubber dispersions of other reactive diluents, such as BDDGE, improves fracture toughness but sacrifices glass transition temperature and modulus significantly.

Incorporation of core shell rubber dispersions of liquid epoxy resins, such as D.E.R.™ 383, improves fracture toughness while maintaining Tg, but modulus of the toughened epoxy decreases significantly.

1. A composition comprising:
a) 45 to 97 weight percent of a divinylarene dioxide; and
b) 3 to 55 weight percent of a core shell rubber comprising a rubber particle core and a shell layer wherein said core shell rubber has a particle size of from 0.01 μm to 0.50 μm.

2. A formulation in accordance with claim 1 wherein said divinylarene dioxide comprises divinylbenzene dioxide.

3. A formulation in accordance with claim 1 wherein the divinylarene dioxide includes an impurity level of less than 50 percent.

4. A formulation in accordance with claim 1 wherein the core shell rubber has a core selected from the group consisting of a butadiene core, a silicone core, a butadiene-styrene copolymer core, and combinations thereof.

5. A formulation in accordance with claim 1 wherein the core shell rubber has a shell selected from the group consisting of a methyl methacrylate shell, a styrene shell, and combinations thereof.

6. A formulation in accordance with claim 1 wherein said core shell rubber further comprises an intermediate layer.

7. A process for preparing the composition of claim 1 comprising dispersing a core shell rubber into a divinylarene dioxide component with a high shear mixer under dispersion conditions comprising a dispersion temperature of 40° C. to 100° C., a Reynolds Number greater than 10, and a dispersion time of from 30 minutes to 80 minutes.

8. A composition comprising:
a) an epoxy resin;
b) a hardener; and
c) a toughener comprising
i) 45 to 97 weight percent of a divinylarene dioxide; and
ii) 3 to 55 weight percent of a core shell rubber comprising a rubber particle core and a shell layer wherein said core shell rubber has a particle size of from 0.01 μm to 0.03 μm.

9. A composition in accordance with claim 8 wherein the hardener is selected from the group consisting of aliphatic amines, cycloaliphatic amines, aromatic amines, anhydrides, amidoamines, polyamide, dicyandamide, and cyanate esters.

10. A composition in accordance with claim 8 wherein said core shell rubber further comprises an intermediate layer.

11. A formulation in accordance with claim 8 wherein said divinylarene dioxide comprises divinylbenzene dioxide.

12. A formulation in accordance with claim 8 wherein the divinylarene dioxide includes an impurity level of less than 50 percent.

13. A composite prepared from the composition of claim 1.

14. A coating prepared from the composition of claim 1.

15. An adhesive prepared from the composition of claim 1.
